(19) United States
(12) Patent Application Publication
(10) Pub. No.: US 2014/0279586 A1
(43) Pub. Date: Sep. 18, 2014

(54) INVOICE NUMBER GAP ALERTING AND PROCESSING

(71) Applicant: Akio Kita, Dossenheim (DE)

(72) Inventor: Akio Kita, Dossenheim (DE)

(73) Assignee: SAP AG, Walldorf (DE)

(21) Appl. No.: 13/797,425

(22) Filed: Mar. 12, 2013

(51) Int. Cl. G06Q 10/10; G06Q 50/18

(52) U.S. Cl. CPC G06Q 10/10; G06Q 50/18
USPC 705/311

(57) ABSTRACT

Various embodiments illustrated and described herein include at least one of systems, methods, and software for invoice gap number alerting and processing. Some such embodiments include monitoring, within a computing system involved in at least one of invoice generation and storing, continuity of invoice numbering. Upon noting a missing invoice number, some embodiments include stopping creation of invoices and pushing an alert to a managing entity responsive to noting the missing invoice number. Input will typically be received from the managing entity regarding a missing invoice number. In response to the received input, various embodiments further facilitate registration of the missing invoice number to enable creation of the new invoice and restart creation of invoices.

### BACKGROUND INFORMATION

In some jurisdictions, invoice issuers are legally required to assign a digital signature to an invoice/billing document. The digital signature in Portugal, for example, must include four characters of the digital signature (i.e. the first, eleventh, twenty-first, and thirty-first characters from the digital signature) on the face of the document for the invoice or billing document legally compliant. Continuing with the requirements of Portugal, to generate the digital signature, the invoice number, invoice date, gross amount, system date and time, and the digital signature of the preceding document are used in a hash calculation to generate the digital signature. If the current document number is “n”, the preceding document number is “n−1”. All document numbers (i.e., invoice numbers) must have consecutive numbering so that all invoice and billing documents are in a chain. However, if the digital signature of the preceding document (i.e., document number n−1) cannot be retrieved, the digital signature generation for the current document is not possible and the legally compliant invoice or billing document cannot be issued. Further, when an invoice or billing document number is a lost (i.e., skipped) for any reason and a numbering gap is introduced, an invoice and billing document generation system cannot generate a needed digital signature to affix to the face of the document. In such instances of a gap in invoice and billing document numbering, the missing number and a reason must be reported to an authority, such as a government tax authority. The digital signature generation and therefore also invoice and billing document generation can be continued only after the gap number is registered.

Such invoice and billing document registry requirement present cash flow issues to businesses. The greater the time for an invoice to be issued, the greater time the business goes without getting paid. However, the business continues to incur expenses.

### BRIEF DESCRIPTION OF THE DRAWINGS

FIG. 1 is a logical block diagram of a system, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Invoice numbering gaps in certain jurisdictions pose significant business issues. For example, some jurisdictions, such as Portugal, require use of a previous invoice number in generating a digital signature for a new invoice. When there is a gap in invoice numbers, a digital signature for a new invoice cannot be generated, thereby freezing an invoice generation process. To restart the invoice generation process, some embodiments include storing the missing invoice number and a reason for the missing number in a registry of an invoice generation system. The missing number and the reason are then reported to an appropriate government designated authority. This reporting is typically through an electronic communication, such as by calling a web service, storing data to a designated database of the authority, sending an email including the relevant data, among other possible data communication modes and mechanisms.

To determine when a sequential invoice number has been missed, some embodiments include a listener process that monitors invoice numbering data. The listener process may be a part of an invoice generation process or a separate process. Regardless, the listener process, in some embodiments, determines when one or more invoice numbers have been skipped and triggers a notification process or sends notifications itself. The listener process may constantly monitor invoice numbering data or may be a scheduled process that executes according to a configured period. The configured period may be a matter of minutes (i.e., every fifteen or thirty minutes), a matter of hours (i.e., once every hour, every two hours, every six hours), a matter of days (i.e., once a day, once every two days), a matter of weeks (i.e., once a week, twice a week, once every two weeks), and other periods depending on the preferences of a business.

Notifications in such embodiments are sent to a managing entity, such as a manager, a responsible delegate, a group of people, a single group inbox, and the like. The message may be sent as an email, an SMS text message, a mobile device app specific message, a text-based chat client message, and other message types, depending on the particular embodiment. The message informs the managing entity of the skipped invoice number and requests input as to a reason for the skipped number. The message to the managing entity may include information as to a possible, likely, or actually cause of the skipped number(s).

The managing entity may then provide input as to the cause of the skipped invoice number, such as by reply SMS message or text-based chat message. In other embodiments, the managing entity can provide such input via a user interface, such as a web browser based user interface, a mobile device app user interface, an interface of an enterprise application or app, among other possible user interfaces. The skipped invoice number and a reason for the skipped number are then typically stored to a registry of the invoice issuing business, which may be a database table, flat file, or other data structure. Information regarding the skipped invoice number and the reasoning therefore may also be sent to a registry of a jurisdictional authority, such as a tax authority. The invoice generation process may then be restarted and digital signatures for invoices can again be generated.

Such embodiments operate to quickly identify invoice generation issues to reduce an amount of time in which invoices cannot be generated and issued. By proactively monitoring invoice numbering data, businesses are able to keep their invoicing operations productive which helps keep account receivable times to a minimum. These and other embodiments are illustrated and described herein.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

FIG. 1 is a logical block diagram of a system 100, according to an example embodiment. The system 100 includes an example of a computing environment within which various embodiments may be deployed. Some embodiments may include a great or a fewer number of elements.

The system 100 includes an invoice generation module 102. The invoice generation module 102 typically executes on one or more server class computing devices. The invoice generation module 102 may be a standalone process that executes against data stored in a database or accessible via one or more of data interfaces and services of another computer application, such as an enterprise resource planning (ERP) or customer relationship management (CRM) application. In other embodiments, the invoice generation module 102 may be one or more processes that execute within a larger system, such as an ERP or CRM application, or modules thereof.

The system 100 further includes a network 104, a messaging system 106, client computing devices 108, 110, an invoice numbering registration system 112, and an invoice numbering registration system database 114.

The network 104 is intended to represent one or more networks over which data can be communicated. Such networks may include one or more of a local area network (LAN), wide area network (WAN), system area network (SAN), virtual private network (VPN), the Internet, and other network types.

The messaging system 106 may be one or more of a variety of different types of systems that operate to receive and communicate messages via the network 104. Thus, the messaging system 106, in different embodiments, may be one or more of an email system, a groupware system, a text messaging system, a text-based chat system, a mailbox-type system where data is transmitted and retrieved or relayed to computing devices or applications of users, or other system capable of facilitating message or data communication between the invoice generation module and at least one managing entity user.

The client computing devices 108, 110 may include various types of computing devices users may utilize to receive messages from the invoice generation module 102. For example, the client computing device 108 is a mobile computing device, such as a smartphone or tablet device. The client computing device 110 is a personal computer. These and other devices may be utilized in different embodiments. The client computing devices 108, 110 are generally devices on which users can receive and respond to messages from the invoice generation module 102, which may be sent via the messaging system 106 or otherwise over the network 104. The messages may be presented on the client computing devices 108, 110 in any number of ways. Similarly, input may be received into the client computing devices 108, 110 in any number of ways, depending on the embodiment, for generation of and sending responses to messages received from the invoice generation module 102. For example, SMS text messages or text-based chat messages may be presented within suitable applications or apps on the client computing devices 108, 110 and input may be received therein. However, in some embodiments, the messages may include a link or otherwise inform a user to view data with regard to an invoice number issue within the invoice generation module 102. Similarly, messages may be send by the invoice generation module 102 to a client computing device 108, 110 application or app that natively include or operate to retrieve an interface within which invoice generation data can be presented with regard to a skipped invoice number. Additionally, some embodiments may utilize a web browser-based interface. Regardless of the messaging and interface type, a client computing device 108, 110 user, upon receipt of a notification of an invoice number issue from the invoice generation module 102, can view relevant data and provide input in response thereto. That input will be communicated to the invoice generation module 102 and utilized to register skipped invoice numbers with the invoice numbering registration system 112 and restart generation of invoices.

The invoice generation module 102 operates to generate invoices for goods and services sold by a business. In operation, the invoice generation module 102 accesses data from and generates data stored to an invoice database and gap registry 103. The invoice database and gap registry 103 may be a database under management of a database management system (DBMS), a set of stored files, or other data storage system. The invoice database and gap registry 103 may be standalone. In other embodiments, the invoice database and gap registry 103 may be a portion of or a set of tables of another application, such as an ERP or CRM application.

The invoice generation module 102 includes a listener process that is executed to identify gaps in invoice numbering. The listener process may execute against data stored in one or more of the invoice database and gap registry 103, a database of data of one or more other applications, or other invoice-related data depending on the particular embodiment. Upon identification of a gap in invoice numbers, the listener process operates to retrieve data related to the missing invoice number(s) and to generate and send a message to a managing entity, such as by sending a message to a client computing device 108, 110 of the managing entity, informing the managing entity of the invoice numbering gap. The message may include the retrieved data related to the missing invoice number(s) or information determined therefrom, such as an error code or description thereof that is descriptive of a reason for the skipped invoice number(s). Such an error code or description thereof may identify a particular type of system error that occurred that is an actual or likely cause of the invoice numbering gap. The actual reason(s) for an invoice numbering gap can be numerous, but often will relate to system or data errors. As mentioned above, the managing entity may be an individual, a role assigned to one or more individuals, a group of individuals, a department, and the like.

The invoice generation module 102, in response to a message sent to a client computing device 108, 110 of the managing entity, receives and stores input with regard to a reason for the missing invoice number(s). Data of the message, in some embodiments, may then be stored to the invoice database and gap registry 103. Further, the invoice generation module 102 will communicate data to the invoice numbering registration system 112. The data communicated to the invoice numbering registration system 112 will typically include at least one or more skipped invoice numbers and a reason why each of the invoice numbers was skipped. The invoice numbering registration system 112 may further store such received data to an invoice number registration system database 114. Upon successfully transmitting the missing invoice number data to the invoice numbering registration system 112, the invoice generation module 102 may restart invoice generation.

FIG. 2 is a block flow diagram of a method 200, according to an example embodiment. The method 200 is an example of a method an invoice generation process or module, such as invoice generation module 102 of FIG. 1, may execute.

The method 200 includes monitoring 202, within a computing system involved in at least one of invoice generation and storing, continuity of invoice numbering. Upon noting 204 a missing invoice number when creating a new invoice, the method 200 includes stopping 206 creation of invoices and pushing 208 an alert to a managing entity responsive to noting the missing invoice number. The method 200 further includes facilitating 210 registration of the missing invoice number to enable creation of the new invoice and restarting creation of invoices.

Noting 204 that an invoice number is missing may include comparing a number of an invoice being generated with a previously issued invoice with a highest preceding number having a status or other data indicating the invoice was issued or at least properly generated. When the comparing reveals the current invoice does not have a next sequential number, a gap in invoice numbers exists. Other methods of determining a gap in invoice numbers may be implemented in different embodiments. Further, invoice numbers in some embodiments, may instead include other identifying data, such as letter, symbols, and the like. In such embodiments, different forms of sequence checking may be performed taking into account the form of invoice identifying data. For example, ASCII character values may be considered.

In some embodiments, pushing 208 the alert to a managing entity includes retrieving data identifying one or more messaging accounts of users associated with the managing entity, such as from a configuration setting repository or a database. The accounts may be SMS text messaging accounts, email accounts, a postbox account within an application dedicated to invoice processing or an application of which the invoice processing is a part, or other account. After identifying one or more managing entity accounts to which the alert is to be sent, pushing 208 the alert includes generating a message suitable for transmission based on a type of each particular account. The generated message(s) may then be communicated either directly to the particular account(s) or indirectly via one or more messaging systems.

FIG. 3 is a block flow diagram of a method, according to an example embodiment. The method illustrated in FIG. 3 is an example of a method of facilitating 210 registration of the missing invoice number(s) to enable creation of the new invoice and restarting creation of invoice of the method 200 illustrated and described with regard to FIG. 2. This embodiment includes receiving 302, in an electronic form, missing invoice registration data from the managing entity, such as from an app or application executing on a client computing device 108, 110 of FIG. 1 that receives input from an managing entity user and transmits data representative of such input to the invoice generation module 102 of FIG. 1. The invoice registration data will typically include data representative of a reason for the missing invoice number, such as data identifying a system or data error, an invoice cancellation, or data representative of one or more other reasons as to why an invoice number was skipped.

The facilitating 210 registration of the missing invoice number(s) may further include storing 304 the received missing invoice registration data in association with data representative of the missing invoice number. For example, storing 304 such data may include storing the data in the invoice database and gap registry 103 of FIG. 1. The storing 304 may further include transmitting the received missing invoice registration data in a prescribed form to the invoice number registration system 112 of FIG. 1. Once the data is stored 304, the facilitating 210 registration of the missing invoice number(s) may then initiate 306 generation of the new invoice.

Generation of the new invoice may include generating hash data associated with the new invoice that is to be affixed, in whole or in part, to an image or printed instance of the new invoice and, in some embodiments, stored with data representative of the invoice. The hash in such embodiments may be calculated based on data from a hash calculated for an immediately preceding invoice and data of the invoice data. In instances where the previous invoice number was skipped, the hash may be calculated based on hash data generated with regard to an invoice immediately preceding the skipped invoice number(s). However, in other embodiments, other hash data may be utilized or not utilized based on a particular legal or accounting requirement based on a jurisdiction for which the invoice is generated or an accounting standard the business adheres to.

The hash function applied to generate the hash data may be one of various well-known hash functions. The particular hash function utilized may be designated by a jurisdictional authority or an accounting standard. However, in other embodiments, the hash function utilized may be chosen as a configuration setting or provided as a default of the invoice generation module 102 of FIG. 1. Examples of hashing functions include the Bernstein hash, Fowler-Noll-Vo hash function, Jenkins hash function, Pearson Hashing, Zobrist hashing, among others. Other embodiments may utilize a cryptographic hash function, such as RSA, PGP, among others. In some embodiments, the invoice generation module 102 may be part of a larger system, such as an ERP system, that includes a platform encryption service that produces a hash value based on received data. The platform encryption service may be utilized in such embodiments.

In some embodiments, data from the hash is utilized in generating a digital signature to be affixed, in whole or in part, to an image or printed instance of the new invoice and, in some embodiments, stored with data representative of the invoice. A format of the digital signature may be dictated by a jurisdictional authority, statute, or regulation. In other embodiments, the format of the digital signature may be dictated by an accounting standard. Regardless of the format, the format may proscribe specific characters from the hash be included in the digital signature or all characters. Once the hash is calculated, the digital signature is determined and affixed or stored accordingly with regard to the invoice being generated.

With regard to the digital signature, and returning the method 200 of FIG. 2, stopping 206 creation of invoices is cause by an inability to generate a hash and therefore a digital signature as the data needed to create a hash from which the digital signature is generated is unavailable. The data is unavailable as a hash created with regard to an immediately preceding invoice does not exist as that invoice was skipped.

FIG. 4 is a block diagram of a computing device, according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a non-transitory computer-readable medium. For example, a computer program 425 capable of performing one or more of the methods illustrated and described herein may be stored to a non-transitory computer readable medium. An example of such a computer program 425 is the invoice generation module 102 illustrated and described with regard to FIG. 1.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
monitoring, within a computing system involved in at least one of invoice generation and storing, continuity of invoice numbering;
upon noting a missing invoice number when creating a new invoice:
stopping creation of invoices;
pushing an alert to a managing entity responsive to noting the missing invoice number; and
facilitating registration of the missing invoice number to enable creation of the new invoice and restarting creation of invoices.

2. The method of claim 1, wherein:
pushing an alert to a managing entity includes generating and sending an electronic message to a messaging account or device of at least one individual; and
facilitating registration of the missing invoice to enable creation of the new invoice and restarting creation of invoices includes:
receiving, in an electronic form, missing invoice registration data from the managing entity;
storing the received missing invoice registration data in association with data representative of the missing invoice number; and
initiating generation of the new invoice.

3. The method of claim 2, wherein the invoice registration data includes data representative of a reason for the missing invoice number.

4. The method of claim 3, further comprising generating a hash of data associated with the new invoice.

5. The method of claim 4, wherein the data on which the hash is calculated includes data from a hash calculated for an immediately preceding invoice and new invoice data.

6. The method of claim 4, wherein stopping creation of invoices comprises stopping creation of a digital signature to be included with each respective invoice.

7. The method of claim 6, wherein the digital signature is an encryption of the hash.

8. The method of claim 1, wherein the registration of the missing invoice includes storing a digital signature generated from a hash of missing invoice registration data and transmitting data with regard to the missing invoice to a missing invoice registry.

9. A non-transitory computer-readable storage medium, with instructions stored thereon, which when executed by at least one processor of at least one computing device, cause the at least one computing device to:
monitor, within a computing system involved in at least one of invoice generation and storing, continuity of invoice numbering;
upon noting a missing invoice number when creating a new invoice:
stop creation of invoices;
push an alert to a managing entity responsive to noting the missing invoice number; and
facilitate registration of the missing invoice number to enable creation of the new invoice and restart creation of invoices.

10. The non-transitory computer-readable storage medium of claim 9, wherein:
pushing an alert to a managing entity includes generating and sending an electronic message to a messaging account or device of at least one individual; and
facilitating registration of the missing invoice to enable creation of the new invoice and restarting creation of invoices includes:
receiving, in an electronic form, missing invoice registration data from the managing entity;
storing the received missing invoice registration data in association with data representative of the missing invoice number; and
initiating generation of the new invoice.

11. The non-transitory computer-readable storage medium of claim 10, wherein the invoice registration data includes data representative of a reason for the missing invoice number.

12. The non-transitory computer-readable storage medium of claim 11, with further instructions stored thereon, which when executed by the at least one processor further cause the at least one computing device to:
generate a hash of data associated with the new invoice.

13. The non-transitory computer-readable storage medium of 12, wherein the data on which the hash is calculated includes data from a hash calculated for an immediately preceding invoice and new invoice data.

14. The non-transitory computer-readable storage medium of claim 12, wherein stopping creation of invoices comprises stopping creation of a digital signature to be included with each respective invoice.

15. The non-transitory computer-readable storage medium of claim 14, wherein the digital signature is an encryption of the hash.

16. The non-transitory computer-readable storage medium of claim 9, wherein the registration of the missing invoice includes storing a digital signature generated from a hash of missing invoice registration data and transmitting data with regard to the missing invoice to a missing invoice registry.

17. A system comprising:
at least one processor, at least one memory device, and at least one network interface device;
an instruction set stored on the at least one memory device and executable by the at least one processor to:
monitor, within a stored data set including data representative of invoices, continuity of invoice numbering;
upon noting a missing invoice number when creating a new invoice:
stop creation of invoices;
push an alert, via the at least one network interface device, to a managing entity responsive to noting the missing invoice number; and
facilitate registration of the missing invoice number to enable creation of the new invoice and restart creation of invoices.

18. The system of claim 17, wherein:
pushing an alert to a managing entity includes generating and sending an electronic message, via the at least one network interface device, to a messaging account or device of at least one individual; and
facilitating registration of the missing invoice to enable creation of the new invoice and restarting creation of invoices includes:
receiving, via the at least one network interface device in an electronic form, missing invoice registration data from the managing entity;
storing, on the at least one memory device, the received missing invoice registration data in association with data representative of the missing invoice number; and
initiating generation of the new invoice.

19. The system of claim 18, wherein the invoice registration data includes data representative of a reason for the missing invoice number.

20. The system of claim 19, wherein the instruction set is further executable by the at least one processor to:
generate a hash of data associated with the new invoice, wherein the data on which the hash is calculated includes data from a hash calculated for an immediately preceding invoice and new invoice data.
